(19) United States
(12) Patent Application Publication
(10) Pub. No.: US 2025/0076818 A1
(43) Pub. Date: Mar. 6, 2025

(54) ELECTRONIC TIMEPIECE

(71) Applicant: CASIO COMPUTER CO., LTD., Tokyo (JP)

(72) Inventor: Ryoichi KUNIMI, Tokyo (JP)

(73) Assignee: CASIO COMPUTER CO., LTD., Tokyo (JP)

(21) Appl. No.: 18/818,991

(22) Filed: Aug. 29, 2024

(30) Foreign Application Priority Data
Aug. 31, 2023 (JP) 2023-140646

(51) Int. Cl. G04C 17/00; G04C 10/02

(52) U.S. Cl. CPC G04C 17/0058; G04C 10/02

(57) ABSTRACT

An electronic timepiece includes a rotatable annular member, a substrate having at least one protrusion, and a sheet-like component disposed between the substrate and the annular member. The sheet-like component is controlled in position by the at least one protrusion. The annular member is supported by the at least one protrusion.

### REFERENCE TO RELATED APPLICATIONS

This application is based upon and claims the benefit of priority from the prior Japanese Patent Application No. 2023-140646, filed on Aug. 31, 2023, the entire contents, including the description, claims, abstract and drawings, of which are incorporated herein by reference.

### TECHNICAL FIELD

The present disclosure relates to an electronic timepiece.

### DESCRIPTION OF RELATED ART

An electronic device, such as a timepiece, has a case and a large number of components that are assembled inside the case. For relative positioning of the components, protrusions, pins and/or the like are used.

In a technology disclosed in JP 2017-37057 A, a baseplate, a sheet-like component, a date indicator and a solar panel that are laid on top of one another are housed in a case. A plurality of protrusions is formed on the baseplate, a plurality of holes is formed in a magnetic shield plate as the sheet-like component, and the magnetic shield plate is positioned by the protrusions being fitted into the respective holes. These protrusions are arranged along the inner circumference of the date indicator, and the solar panel is supported by convex parts from underneath. Thus, the protrusions play the dual roles of positioning the magnetic shield plate as the sheet-like component and supporting the solar panel.

### SUMMARY OF THE INVENTION

According to an aspect of the present disclosure, there is provided an electronic timepiece including:
a rotatable annular member;
a substrate having at least one protrusion; and
a sheet-like component disposed between the substrate and the annular member,
wherein the sheet-like component is controlled in position by the at least one protrusion, and
wherein the annular member is supported by the at least one protrusion.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is an exploded perspective view showing the interior of an electronic timepiece;

FIG. 2 is a perspective view of a main plate and a spacer in the electronic timepiece;

FIG. 3 is a perspective view of the main plate and a solar panel in the electronic timepiece;

FIG. 4 is a plan view showing the interior of the electronic timepiece;

FIG. 5 is a sectional view showing a plane taken along line V-V shown in FIG. 4;

FIG. 6 is an enlarged view of part of FIG. 2;

FIG. 7 is a perspective view showing the back of a date display plate;

FIG. 8 is a perspective view of the main plate and the solar panel in a modification;

FIG. 9 is a perspective view of the main plate and the solar panel in a modification;

FIG. 10 is a sectional view showing where the date display plate is set in a comparative example; and

FIG. 11 is a sectional view showing where the date display plate is set in the comparative example.

### DETAILED DESCRIPTION

Hereinafter one or more embodiments will be described with reference to the drawings. Features and technical effects of the embodiments will be understood from the following detailed description and the drawings. However, the scope of the present disclosure is not limited to the embodiments disclosed below. The drawings are provided for illustrative purposes only, and therefore the scope of the present disclosure is not limited to the illustrated examples either.

Hereinafter ordinal numbers, such as “first” and “second”, may be attached to objects having the same name. The ordinal numbers are used only for distinguishing objects provided with the same name from one another, and not intended to limit such objects to specific objects or to specify the order, ranking, sequence, classes, priority, inferiority or the like of the objects.

### 1. Electronic Timepiece

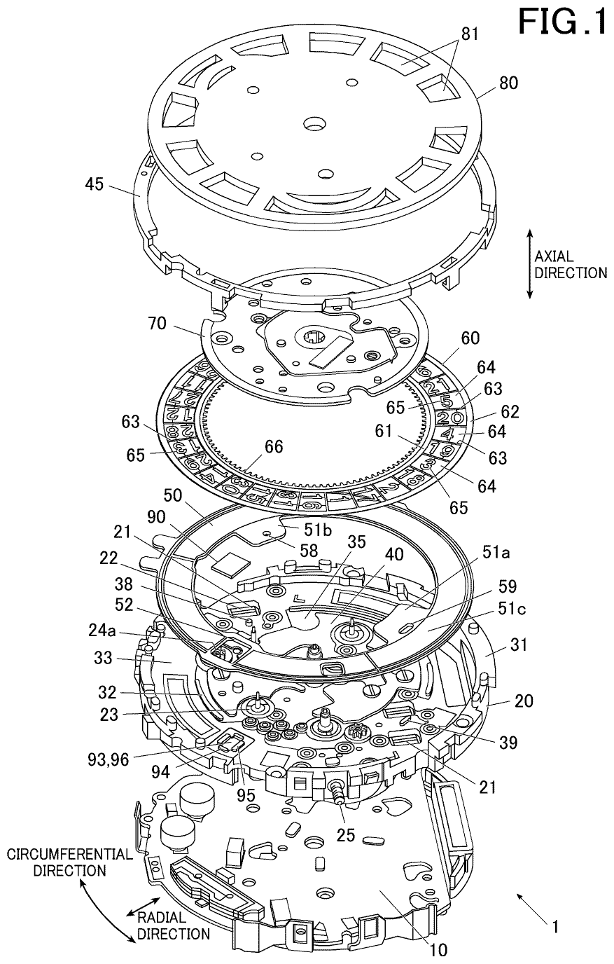

FIG. 1 is an exploded perspective view showing the interior of an electronic timepiece 1. The electronic timepiece 1 is a timepiece indicating time. The electronic timepiece 1 has a case, and components of the electronic timepiece 1 shown in FIG. 1 are housed in the case. The case is attached to an arm (wrist) of a user with an armband or an arm belt. The case includes a flat cylindrical or frame-shaped case body made of metal or resin, a transparent crystal made of resin or glass, and a back cover made of metal or resin. The crystal is fixed to the front of the case body to cover the hollow (opening/space) of the case body, and the back cover is fixed to the back of the case body to cover the hollow of the case body.

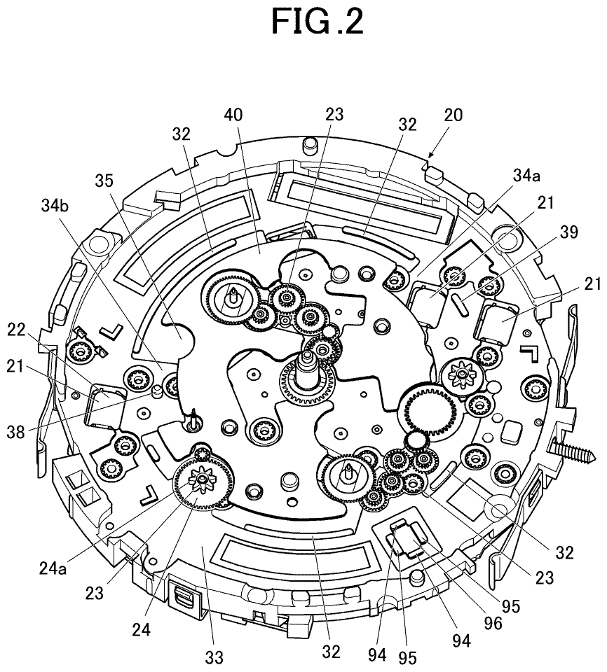

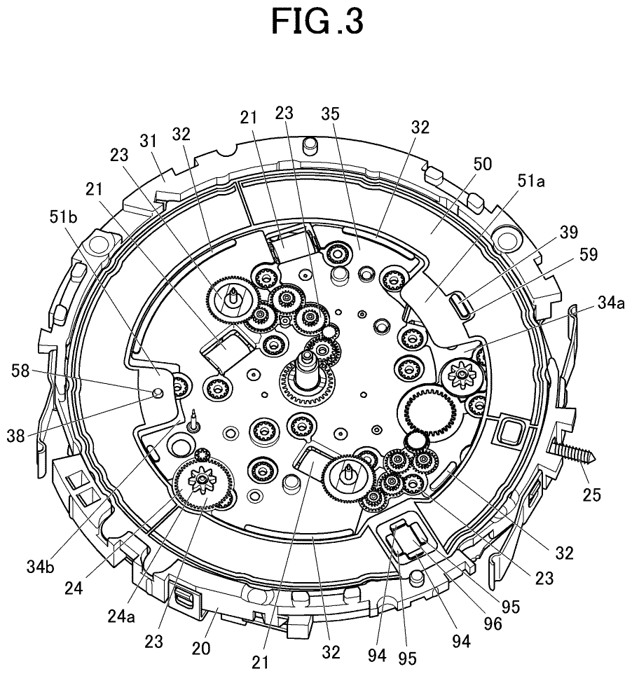

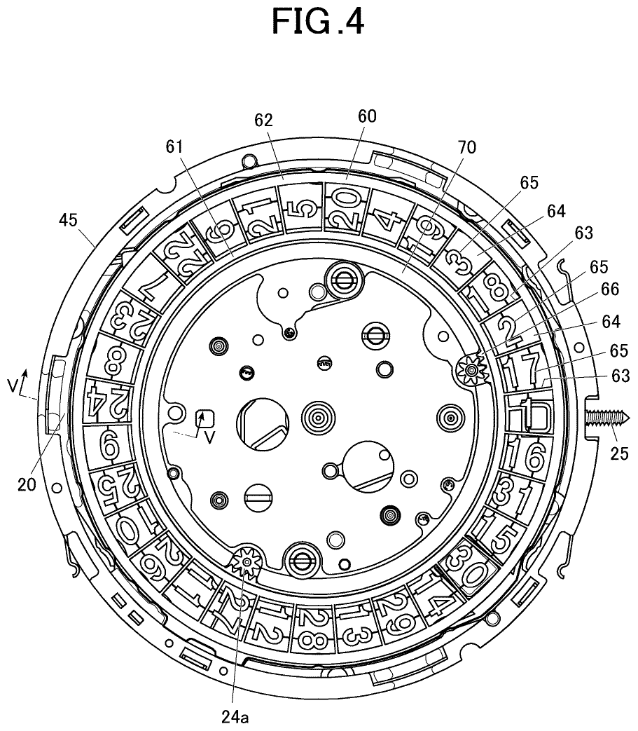

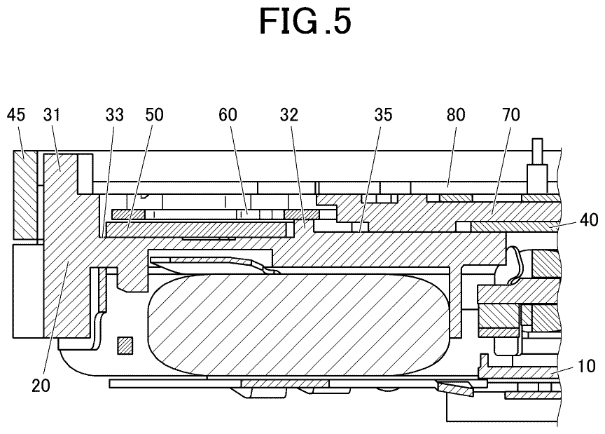

As shown in FIG. 1, the electronic timepiece 1 includes, in order from the back to the front, a circuit board 10, a main plate 20 (substrate), a spacer 40, a solar panel 50 (sheet-like component), a date indicator 60 (annular member), a date indicator maintaining plate 70 (hold-down member) and a dial 80. The electronic timepiece 1 further includes a frame 45, a date display plate 90 and double-sided adhesive tape 93. Hereinafter these components will be described in detail with reference to FIG. 1 to FIG. 5. FIG. 2 is a perspective view of the main plate 20 and the spacer 40. FIG. 3 is a perspective view of the main plate 20 and the solar panel 50. FIG. 4 is a plan view showing the interior of the case. FIG. 4 shows the interior of the case as viewed from the side where the crystal is provided toward the side where the back cover is provided. FIG. 4 does not show the dial 80. FIG. 5 is a sectional view taken along line V-V shown in FIG. 4 as viewed in the arrow direction.

### (1) Circuit Board

The circuit board 10 has electric components mounted thereon. Examples of the electric components include an antenna, a transmitter/receiver with an antenna, a light emitting element, a terminal, an integrated circuit (IC) chip and a rechargeable battery.

### (2) Main Plate (Substrate)

As shown in FIG. 1, the main plate 20 is laid on the front of the circuit board 10. In the present disclosure, the front of each component of the electronic timepiece 1 refers to a face thereof oriented toward the crystal, and the back of each component of the electronic timepiece 1 refers to a face thereof oriented toward the back cover.

The shape of the main plate 20 is based on a circular plate centered on a central axis that passes through the center of the main plate 20. Hereafter the direction parallel to the central axis that passes through the center of the main plate 20 is referred to as an axial direction, the direction along a circle around the central axis is referred to as a circumferential direction, and the direction along a diameter perpendicular to the central axis is referred to as a radial direction. The direction from the front toward the back of the main plate 20 and its opposite direction are parallel to the axial direction. The thickness direction of the main plate 20 is parallel to the axial direction.

The main plate 20 is a substrate to which components such as a plurality of motors 21, a plurality of wheel train (train-of-wheels) mechanisms 23, a crown 25, the solar panel 50 and the spacer 40 are attached. In order that these components can be attached to, mounted on, stuck to, fixed to, supported by, held by or arranged on the main plate 20 to be fitted well, the main plate 20 has pins, protrusions, ribs, recesses, holes, notches, grooves, female screws and/or the like. A motor 22 of the plurality of motors 21 is connected to a wheel train mechanism 24 of the plurality of wheel train mechanisms 23, and the wheel train mechanism 24 is connected to the date indicator 60, so that the date indicator 60 is driven to rotate by the motor 22 and the wheel train mechanism 24. The other motors 21 and the other wheel train mechanisms 23 drive and rotate hands, such as a second hand, a minute hand, an hour hand and/or a function hand(s).

In order that the solar panel 50 and the spacer 40 can be arranged on the front of the main plate 20 such that the solar panel 50, the spacer 40, the date display plate 90 and so forth are fitted well, the front of the main plate 20 is formed as follows.

The main plate 20 has a convex part 31 at the outer circumference of the front of the main plate 20. The convex part 31 is formed along the outer circumference of the front of the main plate 20. The convex part 31 is cut in places at the outer circumference of the front of main plate 20.

The main plate 20 has a plurality of first protrusions 32 on the front of the main plate 20. These first protrusions 32 are formed to be concentric arcs extending in the circumferential direction at positions radially inward from the convex part 31. The radial width of the first protrusions 32 is less than the width of the date indicator 60, which will be described later, from the inner circumference to the outer circumference thereof. The radial width of the first protrusions 32 refers to a dimension of each first protrusion 32 from the inner edge to the outer edge thereof in the radial direction.

The main plate 20 has a first arrangement region 33 on the front of the main plate 20. The first arrangement region 33 is oriented toward the crystal. The first arrangement region 33 extends in the circumferential direction between the convex part 31 and the first protrusions 32. The first arrangement region 33 partly extends between the first protrusions 32 in the radial direction inward from the first protrusions 32, and those parts are referred to as a first extension 34a and a second extension 34b. In this embodiment, the number of extensions 34a, 34b is two, but may be three or more, or may be one. The first extension 34a and the second extension 34b are arranged substantially symmetrically with respect to the center of the main plate 20. The height position of the first arrangement region 33 is lower than the height position of the top of the convex part 31. Therefore, the convex part 31 protrudes from the first arrangement region 33, and accordingly a step is present between the first arrangement region 33 and the top of the convex part 31. The height position of the first arrangement region 33 is also lower than the height position of the tops of the first protrusions 32. In the present disclosure, the height position refers to a position in the axial direction.

The main plate 20 has a second arrangement region 35 at the center of the front of the main plate 20. The second arrangement region 35 is, like the first arrangement region 33, oriented toward the crystal. Therefore, the second arrangement region 35 faces in the same direction as the first arrangement region 33 faces. The second arrangement region 35 spreads at a position radially inward from the first arrangement region 33. The height position of the second arrangement region 35 is higher than the height position of the first arrangement region 33, and accordingly a step is present between the second arrangement region 35 and the first arrangement region 33. The first protrusions 32 extend in the circumferential direction at the boundary between the first arrangement region 33 and the second arrangement region 35. The height position of the second arrangement region 35 is lower than the height position of the tops of the first protrusions 32. Therefore, the first protrusions 32 protrude from the second arrangement region 35, and accordingly a step is present between the second arrangement region 35 and the tops of the first protrusions 32.

The main plate 20 has a circular boss 38 formed on the second extension 34b of the first arrangement region 33. The boss 38 protrudes from the second extension 34b of the first arrangement region 33. The height position of the top of the boss 38 is higher than the height position of the second arrangement region 35. The height position of the top of the boss 38 is also higher than the height position of the tops of the first protrusions 32. The boss 38 is arranged at a position radially inward from a circle that passes through the first protrusions 32 and a second protrusion 39, which will be described below. The boss 38 is used for positioning the solar panel 50.

The main plate 20 has the second protrusion 39 formed on the first extension 34a of the first arrangement region 33. The second protrusion 39 protrudes from the first extension 34a of the first arrangement region 33. The second protrusion 39 is formed to be an arc extending in the circumferential direction. The radial width of the second protrusion 39 is less than the width of the date indicator 60, which will be described later, from the inner circumference to the outer circumference thereof. The radial width of the second protrusion 39 refers to a dimension of the second protrusion 39 from the inner edge to the outer edge thereof in the radial direction. The second protrusion 39 and the first protrusions 32 are concentric and arranged on the circumference of the same circle. The height position of the top of the second protrusion 39 is higher than the height position of the second arrangement region 35. The height position of the top of the second protrusion 39 is approximately equal to the height position of the tops of the first protrusions 32. The height position of the top of the second protrusion 39 is lower than the height position of the top of the boss 38. The second protrusion 39 is used for preventing the solar panel 50 from rotating.

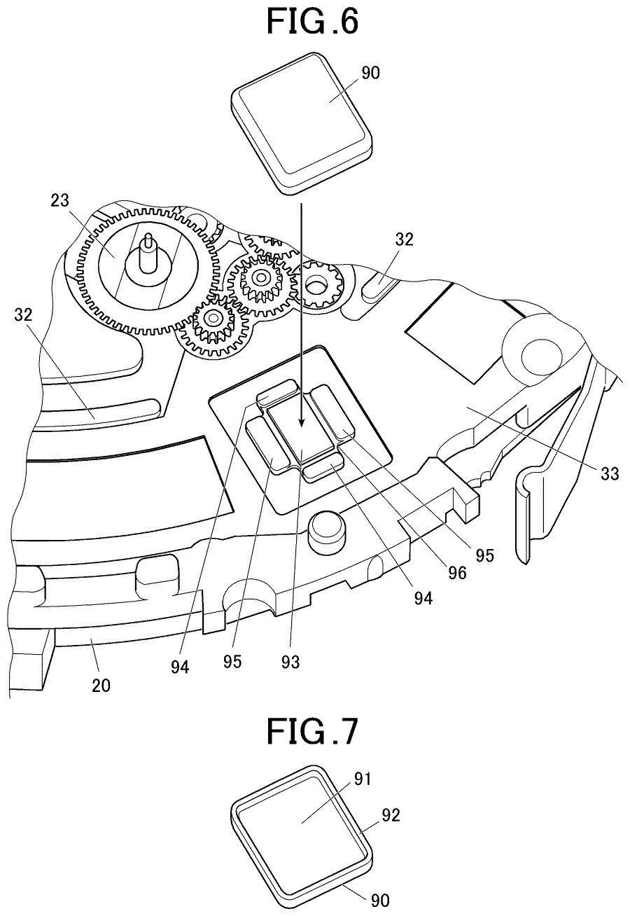

FIG. 6 is an enlarged view of part of FIG. 2. As shown in FIG. 6, the main plate 20 has a pair of guides 94, a pair of guides 95 and an attachment part 96 that are formed in the first arrangement region 33. If positions of the guides 94, 95 and the attachment part 96 are expressed in clock position, the guides 94, 95 and the attachment part 96 are arranged at four thirty. The guides 94, 95 and the attachment part 96 protrude from the first arrangement region 33, and the tops of the guides 94, 95 are higher than the top of the attachment part 96. The attachment part 96 is rectangular (quadrilateral). The guides 94, 95 surround the attachment part 96. The guides 94 are apart from one another in the radial direction with the attachment part 96 in between, and arranged along one pair of opposite sides of the attachment part 96. The guides 95 are apart from one another in the circumferential direction with the attachment part 96 in between, and arranged along the other pair of opposite sides of the attachment part 96. The guides 94 and the guides 95 are apart from one another so that they do not form corners. The planar shape of the guides 94, the guides 95 and the attachment part 96 as a whole is rectangular with the four corners cut off. The guides 94, 95 and the attachment part 96 are for specifying/defining the attachment position of the date display plate 90.

The guides 94, 95 and the attachment part 96 may be arranged at three o'clock that is the same position as the crown 25. In this case, the back of the guides 94, 95 and the attachment part 96 may be recessed, and components of the crown 25 may be arranged on the back of the main plate 20 so as to be housed in the recess of the back of the guides 94, 95 and the attachment part 96.

### (3) Frame

As shown in FIG. 1 and FIG. 4, the frame 45 is ring-shaped. The frame 45 is attached to the outer circumference part of the main plate 20.

### (4) Spacer

As shown in FIG. 1, FIG. 2 and FIG. 5, the spacer 40 is in the shape of a thin sheet. The spacer 40 is laid at the center of the front of the main plate 20. More specifically, the spacer 40 is placed in the second arrangement region 35 of the main plate 20. The spacer 40 may be fixed to the main plate 20 with an adhesive, adhesive tape or screws. The spacer 40 may have holes into which convex parts formed on the front of the main plate 20 are fitted.

### (5) Date Display Plate and Double-Sided Adhesive Tape

FIG. 7 is a perspective view showing the back of the date display plate 90. The date display plate 90 shown in FIG. 6, FIG. 7 and so forth is made of a metal material. The date display plate 90 has, on its back, a rectangular concave part 91 and a frame 92 that surrounds the concave part 91. Since adjacent sides (edges) of the frame 92 form corners of the frame 92, the corners of the frame 92 are harder than the sides of the frame 92. The back face of the date display plate 90 faces the guides 94, 95 and the attachment part 96 of the main plate 20, and the guides 94, 95 and the attachment part 96 are fitted into the concave part 91, so that the date display plate 90 is placed on the guides 94, 95. The date display plate 90 adheres to the attachment part 96 with the double-sided adhesive tape 93. If positions of the date display plate 90, the guides 94, 95 and the attachment part 96 are expressed in clock position, the date display plate 90, the guides 94, 95 and the attachment part 96 are arranged at four thirty.

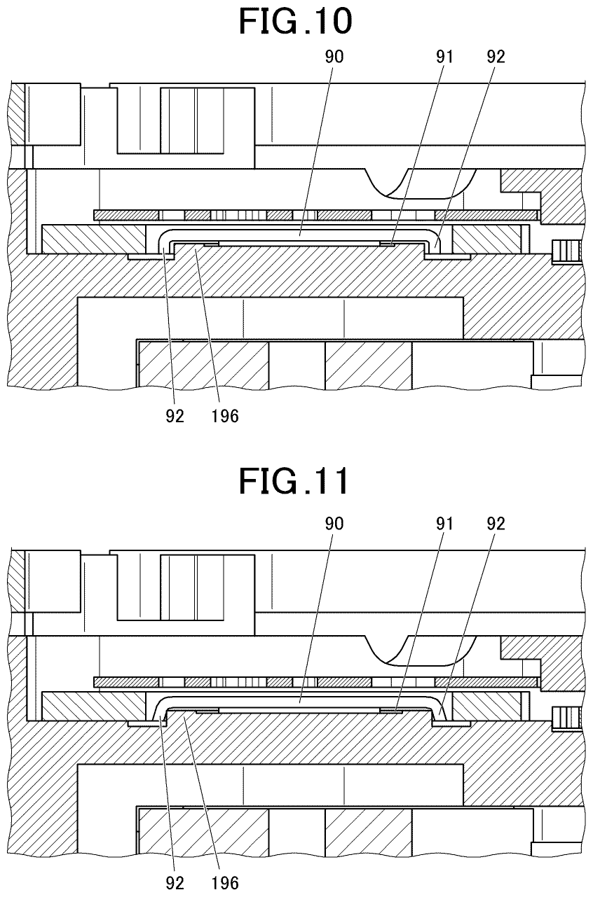

Even if the external shape of the guides 94, 95 is larger or the concave part 91 is smaller due to error in manufacturing, since the planar shape of the guides 94, 95 and the attachment part 96 as a whole is rectangular with the four corners cut off, the guides 94, the guides 95 and the attachment part 96 are easily fitted into the concave part 91 at the time of attachment of the date display plate 90. Hereinafter a comparative example will be described with reference to FIG. 10 and FIG. 11. FIG. 10 and FIG. 11 are sectional views of a comparative example. As shown in FIG. 10 and FIG. 11, in the comparative example, a rectangular convex part 196 is formed in place of the guides 94, the guides 95 and the attachment part 96. As shown in FIG. 10, if the concave part 91 and the rectangular convex part 196 have little or no error in manufacturing, the rectangular convex part 196 is easily fitted into the concave part 91. However, as shown in FIG. 11, if the concave part 91 is smaller than its designed size or the rectangular convex part 196 is larger than its designed size due to error in manufacturing, since the corners of the frame 92 hardly deform when the rectangular convex part 196 is fitted into the concave part 91, it is difficult to fit the rectangular convex part 196 into the concave part 91. Thus, it is understood that no corners formed by the guides 94 and the guides 95 contribute to easiness of attachment of the date display plate 90.

### (6) Solar Panel

As shown in FIG. 1, FIG. 3 and FIG. 5, the solar panel 50 is a sheet-like component in the shape of a thin sheet. The solar panel 50 is ring-shaped (annular) having a virtual center position, which is the center of a region enclosed by the solar panel 50. Hereafter the virtual center position may be referred to as the center of the solar panel 50. The solar panel 50 is placed, around the spacer 40, in the first arrangement region 33 of the main plate 20. The first protrusions 32 are arranged along the inner circumference of the solar panel 50, and the inner circumference of the solar panel 50 is in contact with the first protrusions 32. The first protrusions 32 serve as an indication or reference to arrange the solar panel 50, and the position of the solar panel 50 in the radial direction with respect to the main plate 20 is determined (fixed) by the first protrusions 32. In other words, the solar panel 50 is controlled in position by the first protrusions 32. The position of the solar panel 50 in the circumferential direction cannot be determined by the first protrusions 32 only. A gap may be present between the inner circumference of the solar panel 50 and at least one of the first protrusions 32. The solar panel 50 may adhere to the first arrangement region 33 with double-sided adhesive tape.

The solar panel 50 has one or more photovoltaic elements that receive light and generate electromotive force. The solar panel 50 is electrically connected to the circuit board 10 via a contact or the like, and the electromotive force of the solar panel 50 is supplied to the circuit board 10, or a rechargeable battery is charged with the electromotive force.

The solar panel 50 has a plurality of sheet-like extensions 51a, 51b, namely, a first extension 51a and a second extension 51b, and an annular region 51c. The extensions 51a, 51b extend from the inner circumference of the annular region 51c inward in the radial direction. In this embodiment, the number of extensions 51a, 51b is two, but may be three or more, or may be one. The first extension 51a and the second extension 51b are arranged substantially symmetrically with respect to the center(s) of the solar panel 50 and the main plate 20. The first extension 51a is placed on the first extension 34a of the first arrangement region 33, and the second extension 51b is placed on the second extension 34b of the first arrangement region 33.

The solar panel 50 has a circular hole 58 (second hole) formed in the second extension 51b. The hole 58 passes through the second extension 51b from the front to the back. The boss 38 is fitted into the hole 58, so that the solar panel 50 is positioned. More specifically, in the state in which the position of the solar panel 50 in the radial direction is determined by the first protrusions 32 (i.e., the solar panel 50 is controlled in position by the first protrusions 32), the position of the solar panel 50 in the circumferential direction is determined by the boss 38 and the hole 58. However, with the first protrusions 32, the boss 38 and the hole 58 only, the solar panel 50 may rotate on the boss 38. The second protrusion 39 and a hole 59 (first hole), which will be described below, prevent the rotation.

The thickness of the solar panel 50 is less than the height from the first arrangement region 33 to the top of the boss 38. The boss 38 passes through the hole 58 and protrudes from the front of the solar panel 50.

The solar panel 50 has an arc-shaped hole 59 formed in the first extension 51a. The hole 59 passes through the first extension 51a from the front to the back. The hole 59 and the hole 58 are arranged substantially symmetrically with respect to the center(s) of the solar panel 50 and the main plate 20. The second protrusion 39 is fitted into the hole 59. Since the hole 59 and the second protrusion 39 are arc-shaped, the position of the solar panel 50 in the radial direction and the circumferential direction with respect to the main plate 20 is determined by the second protrusion 39 being fitted into the hole 59. The second protrusion 39 fitted into the hole 59 prevents the solar panel 50 from rotating on the boss 38. Even if the fit tolerance of the hole 59 and the second protrusion 39 is loose, because the fit tolerance of the hole 58 and the boss 38 is tighter than the fit tolerance of the hole 59 and the second protrusion 39, the solar panel 50 is firmly positioned in the radial direction and the circumferential direction with respect to the main plate 20 by the second protrusion 39 and the boss 38 being fitted into the hole 59 and the hole 58, respectively. In other words, by the second protrusion 39, the solar panel 50 is controlled in position and positioned in the end.

The thickness of the solar panel 50 is less than the height from the first arrangement region 33 to the top of the second protrusion 39. The second protrusion 39 passes through the hole 59 and protrudes from the front of the solar panel 50. The thickness of the solar panel 50 is also less than the height from the first arrangement region 33 to the tops of the first protrusions 32.

The solar panel 50 has a rectangular opening 52. The opening 52 passes through the solar panel 50 from the front to the back. The date display plate 90 is fitted into the opening 52.

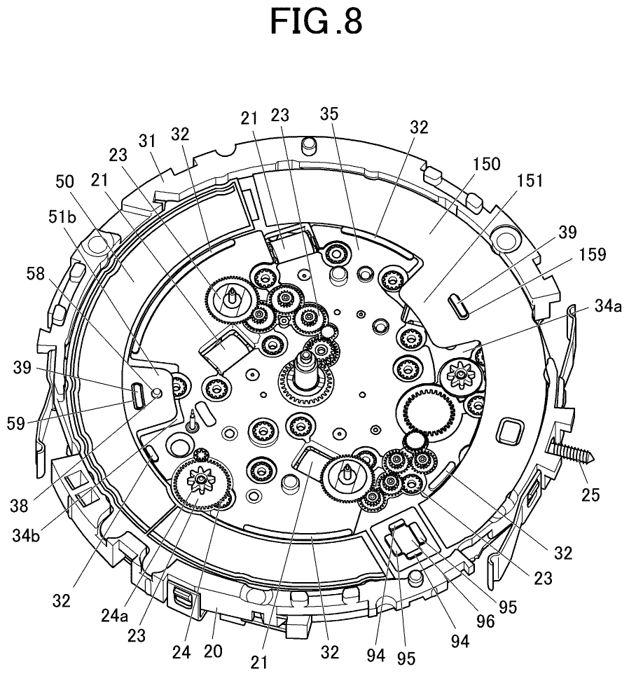

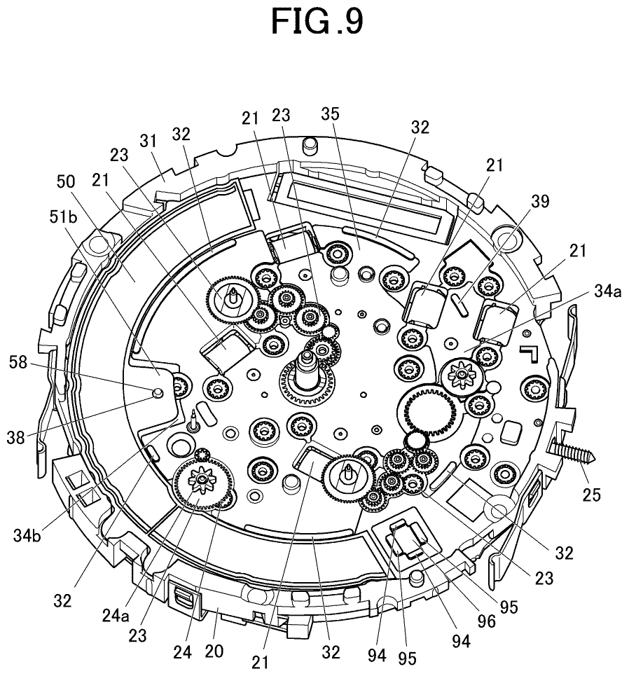

If the solar panel 50 is a gallium solar panel having a high efficiency of electric power generation, the solar panel 50 is expected to generate electric power sufficiently even if the light receiving area of the solar panel 50 is small. Therefore, as shown in FIG. 8 and FIG. 9, the solar panel 50 may be in the shape of an arc like a ring a part of which is absent, namely, may be C-shaped, half-ring-shaped or the like. In this case, as shown in FIG. 8, an arc-shaped decorative sheet 150 having a color very similar to that of the solar panel 50 may be arranged in the absent part to form a ring shape together with the arc-shaped solar panel 50. In this case, the solar panel 50 and the decorative sheet 150 are approximately equal in thickness. Further, in order to make the boundary(ies) between the arc-shaped solar panel 50 and the decorative sheet 150 inconspicuous, a ring-shaped light diffusion sheet may be laid on the front of the arc-shaped solar panel 50 and the decorative sheet 150.

In the case where the solar panel 50 is arc-shaped, as shown in FIG. 8 and FIG. 9, the solar panel 50 has one extension, namely, 51b. In the case where the decorative sheet 150 is provided as shown in FIG. 8, the decorative sheet 150 has a sheet-like extension 151 extending from the inner circumference inward in the radial direction. The position of the extension 151 is the same as that of the extension 51a described above. In the example shown in FIG. 8, a hole 159 into which the second protrusion 39 is fitted is formed in the extension 151 of the decorative sheet 150. In the example shown in FIG. 8, the number of second protrusions 39 is two, and these second protrusions 39 are arranged substantially symmetrically with respect to the center(s) of the solar panel 50 and the main plate 20. In the example shown in FIG. 8, the extension 51b of the solar panel 50 has a hole 59 into which a second protrusion 39 is fitted, in addition to the hole 58 into which the boss 38 is fitted. In the example shown in FIG. 9, the main plate 20 has one second protrusion 39. This second protrusion 39 does not contribute to positioning of the solar panel 50.

### (7) Date Indicator

As shown in FIG. 1, FIG. 4 and FIG. 5, the date indicator 60 is an annular member. The shape of the date indicator 60 is based on a ring (annular) shape around the central axis that passes through the center of the main plate 20. The date indicator 60 is supported by the first protrusions 32 and the second protrusion 39 in the state in which the date indicator 60 lifts off from the solar panel 50. Therefore, no friction is generated between the date indicator 60 and the solar panel 50 when the date indicator 60 rotates. Since the radial width of the arc-shaped second protrusion 39 is less than that of the date indicator 60, friction that is generated between the second protrusion 39 and the date indicator 60 is small. Also, the radial width of the arc-shaped first protrusions 32 is less than that of the date indicator 60. The radial width of the date indicator 60 refers to the width of the date indicator 60 from the inner circumference to the outer circumference thereof. The radial width of the second protrusion 39 refers to a dimension of the second protrusion 39 from the inner edge to the outer edge thereof in the radial direction. The radial width of the first protrusions 32 refers to a dimension of each first protrusion 32 from the inner edge to the outer edge thereof in the radial direction.

The date indicator 60 is made of a metal material, such as stainless steel or titanium alloy. The date indicator 60 has been subjected to character cutting, such as mechanical cutting, stamping, etching, laser beam cutting, sandblasting or water jet cutting. The metallic luster of the date indicator 60 provides the date indicator 60 with a sense of dignity and a sense of luxury. The character cutting provides the date indicator 60 with a three-dimensional appearance and a sense of luxury.

The date indicator 60 has an inner ring 61, an outer ring 62, a plurality of spokes 63, a plurality of openings 64, a plurality of character parts 65 and an internal gear 66. The inner ring 61 is arranged apart from the outer ring 62 inwardly, and the inner ring 61 and the outer ring 62 are concentric. The inner ring 61 is a part of the date indicator 60 close to the inner circumference thereof. The spokes 63 are arranged between the inner ring 61 and the outer ring 62 at intervals in the circumferential direction. These spokes 63 extend in the radial direction so as to build bridges from the inner ring 61 to the outer ring 62. The openings 64 are formed between the spokes 63 adjacent to one another. The openings 64 pass through the date indicator 60 from the front to the back. These openings 64 let sunlight pass through to reach the solar panel 50. The character parts 65 are arranged in the respective openings 64. The character parts 65 are connected to the inner ring 61, the outer ring 62 and/or the spokes 63 by thin links. The internal gear 66 is formed on the inner circumference of the inner ring 61. The internal gear 66 meshes with an output gear 24a of the wheel train mechanism 24.

The inner circumference part of the date indicator 60, namely, the inner ring 61, is placed on the first protrusions 32 and the second protrusion 39, thereby being in contact with the first protrusions 32 and the second protrusion 39. Therefore, resistance torque exerted on the date indicator 60 is minimized. Since the first protrusions 32 and the second protrusion 39 do not form a ring shape but are arc-shaped, the area where (i) the first protrusions 32 and the second protrusion 39 and (ii) the inner ring 61 of the date indicator 60 are in contact with one another is minimized, and the resistance torque exerted on the date indicator 60 is minimized. In contrast, the technology disclosed in JP 2017-37057 A exerts a large amount of resistance torque on the date indicator. This is because the date indicator disclosed in JP 2017-37057 A is almost entirely laid on and in contact with the magnetic shield plate. Therefore, when the date indicator rotates, a large amount of friction is generated between the date indicator and the magnetic shield plate, and this friction acts as resistance to the rotation of the date indicator. It is obvious that the resistance exerted on the date indicator by the magnetic shield plate disclosed in JP 2017-37057 A is larger than that exerted on the date indicator 60 by the first protrusions 32 and the second protrusion 39 of this embodiment.

One of the character parts 65 of the date indicator 60 coincides with the date display plate 90. The character part 65 that coincides with the date display plate 90 indicates the current date.

### (8) Date Indicator Maintaining Plate

As shown in FIG. 1, FIG. 4 and FIG. 5, the date indicator maintaining plate 70 is laid on the spacer 40. The date indicator maintaining plate 70 is disc-shaped. The outer circumference part of the date indicator maintaining plate 70 covers the internal gear 66 of the date indicator 60 from the side where the crystal is provided. The outer circumference part of the date indicator maintaining plate 70 is apart from or in soft contact with the internal gear 66. The soft contact means that the outer circumference part of the date indicator maintaining plate 70 is in contact with the internal gear 66 to the extent that friction between the outer circumference part of the date indicator maintaining plate 70 and the date indicator 60 is hardly generated.

The date indicator maintaining plate 70 goes beyond the edges of the spacer 40 and the second arrangement region 35 and projects toward the extensions 34a, 34b. This projecting part lifts off from the extensions 34a, 34b. The projecting part covers the extensions 51a, 51b of the solar panel 50 from the side where the crystal is provided and holds down the extensions 51a, 51. Because the front face of the solar panel 50 is flush with the front face of the spacer 40, the date indicator maintaining plate 70 does not wobble although it is laid on the spacer 40 and the extensions 51a, 51b of the solar panel 50.

### (9) Dial

As shown in FIG. 1, the dial 80 is laid on the date indicator maintaining plate 70 and the date indicator 60. The dial 80 is supported by the date indicator maintaining plate 70, thereby being apart from the date indicator 60 toward the crystal. The dial 80 is made of a metal material or a resin material. The dial 80 is opaque. The dial 80 has a plurality of openings 81 arranged in the circumferential direction at positions radially outward from the (outer) circumference of the date indicator maintaining plate 70. The openings 81 pass through the dial 80 from the front to the back. These openings 81 let sunlight pass through to reach the date indicator 60 and the solar panel 50. The openings 81 are formed in the dial 80, which makes the dial 80 appear to be three-dimensional. The dial 80 may be transparent. In this case, the openings 81 may not be formed in the dial 80.

### 4. Conclusion

Since the arc-shaped first protrusions 32 are arranged along the inner circumference of the sheet-like solar panel 50, the solar panel 50 is controlled in position in the radial direction by the first protrusions 32. Further, since the arc-shaped second protrusion 39 is fitted into the hole 59 of the solar panel 50, the solar panel 50 is controlled in position in the radial direction and the circumferential direction by the second protrusion 39, thereby being positioned. Since such first protrusions 32 and second protrusion 39 support the date indicator 60, the friction that is generated against the date indicator 60 when the date indicator 60 rotates is reduced.

The solar panel 50 is placed in the first arrangement region 33 on the front of the main plate 20. The second protrusion 39 is formed on the front of the main plate 20, the hole 59 is formed in the solar panel 50, and the second protrusion 39 is fitted into the hole 59. The date indicator 60 is supported by the second protrusion 39 from underneath. Thus, the second protrusion 39 has both the function of positioning the solar panel 50 and the function of supporting the date indicator 60. This eliminates the need to prepare, on the front of the main plate 20, separate protrusions for positioning the solar panel 50 and for supporting the date indicator 60. In other words, even if there is no room on the front of the main plate 20 to prepare (provide) separate protrusions for positioning the solar panel 50 and for supporting the date indicator 60, the second protrusion 39 both positions the solar panel 50 and supports the date indicator 60.

Although the position of the solar panel 50 in the radial direction can be determined by the first protrusions 32 only (i.e., although the solar panel 50 can be controlled in position by the first protrusions 32), the position thereof in the circumferential direction cannot be determined by the first protrusions 32 only. The fit tolerance of the boss 38 and the hole 58 is tight, but, with the boss 38 and the hole 58 only, the solar panel 50 rotates on the boss 38. Meanwhile, although the position of the solar panel 50 in the circumferential direction and the radial direction can be determined by the second protrusion 39 being fitted into the hole 59, if the fit tolerance of the second protrusion 39 and the hole 59 is loose, with the second protrusion 39 and the hole 59 only, the solar panel 50 may deviate from its correct position. Combination of the second protrusion 39 being fitted into the hole 59, the boss 38 being fitted into the hole 58 and the first protrusions 32 being in contact with the inner circumference of the solar panel 50 can firmly position the solar panel 50 and does not cause the solar panel 50 to deviate from its correct position or wobble.

The first protrusions 32 and the second protrusion 39 support the date indicator 60 from underneath without abutting the tooth tip of the internal gear 66 of the date indicator 60. Therefore, the friction that is generated between (i) the date indicator 60 and (ii) the first protrusions 32 and the second protrusion 39 when the date indicator 60 rotates is reduced.

The part of the ring-shaped date indicator 60 close to the inner circumference thereof, namely, not the entire date indicator 60 but the inner ring 61, is supported by the first protrusions 32 and the second protrusion 39. Thus, the area where (i) the first protrusions 32 and the second protrusion 39 and (ii) the date indicator 60 are in contact with one another is minimized, and the friction that is generated between (i) the first protrusions 32 and the second protrusion 39 and (ii) the date indicator 60 is minimized. Also, the torque of the output gear 24a required to rotate the date indicator 60 can be reduced.

The first protrusions 32 and the second protrusion 39 are arc-shaped so as to extend in the circumferential direction, and the radial width of the first protrusions 32 and the second protrusion 39 is less than the width of the date indicator 60 from the inner circumference to the outer circumference thereof. Thus, the area where (i) the first protrusions 32 and the second protrusion 39 and (ii) the date indicator 60 are in contact with one another is minimized, and the friction that is generated between (i) the first protrusions 32 and the second protrusion 39 and (ii) the date indicator 60 is minimized.

The hole 58 and the hole 59 are arranged substantially symmetrically with respect to the center(s) of the solar panel 50 and the main plate 20, and the boss 38 and the second protrusion 39 are arranged substantially symmetrically with respect to the center(s) of the solar panel 50 and the main plate 20, which can stably secure the solar panel 50.

The circular boss 38 is formed on the front of the main plate 20, the circular hole 58 is formed in the solar panel 50, and the boss 38 is fitted into the hole 58. In addition to this, the second protrusion 39 is fitted into the hole 59, which prevents the solar panel 50 from rotating on the boss 38 or deviating from its correct position, namely, positions the solar panel 50.

The tight fit tolerance of the hole 58 and the boss 38 precisely positions the solar panel 50, and the loose fit tolerance of the hole 59 and the second protrusion 39 reliably fits the second protrusion 39 into the hole 59. Thus, both precise positioning of the solar panel 50 and prevention of rotation of the solar panel 50 are achieved.

Since the planar shape of the pair of guides 94 and the pair of guides 95 as a whole is a rectangular frame shape with the four corners cut off, the guides 94, 95 and the attachment part 96 are easily fitted into the concave part 91 at the time of attachment of the date display plate 90.

### 5. Modifications

(I) The electronic timepiece 1 may have a magnetic shield plate having the same planar shape as that of the solar panel 50. The magnetic shield plate is a sheet-like component and placed in the first arrangement region 33 of the main plate 20 in place of the solar panel 50. Therefore, the second protrusion 39 is fitted into a hole formed in a first extension of the magnetic shield plate, and the boss 38 is fitted into a hole formed in a second extension of the magnetic shield plate. The hole formed in the first extension of the magnetic shield plate corresponds to the hole 59 of the solar panel 50, and the hole formed in the second extension of the magnetic shield plate corresponds to the hole 58 of the solar panel 50. The magnetic shield plate is made of a magnetism collecting material, such as cold-rolled steel or Permalloy. The magnetic shield plate covers the motors 21, thereby magnetically shielding the motors 21. If the magnetic shield plate and the solar panel 50 are thin, both the solar panel 50 and the magnetic shield plate may be employed, and the magnetic shield plate may be placed in the first arrangement region 33 of the main plate 20, and the solar panel 50 may be placed on the magnetic shield plate. In the case where both the solar panel 50 and the magnetic shield plate are employed, the boss 38 is fitted into both the hole 58 in the solar panel 50 and the hole in the magnetic shield plate, and the second protrusion 39 is fitted into both the hole 59 in the solar panel 50 and the hole in the magnetic shield plate.

(II) As shown in FIG. 1 to FIG. 3, one second protrusion 39 is formed on the front of the main plate 20. Instead, a plurality of second protrusions 39 may be formed on the front of the main plate 20. In this case, the solar panel 50 has a plurality of first extensions 51a, holes 59 are formed in the respective first extensions 51a, and the second protrusions 39 are fitted into the respective holes 59. Alternatively, holes 59 are formed in one first extension 51a of the solar panel 50, and the second protrusions 39 are fitted into the respective holes 59.

(III) The above (I) and (II) may applied by being combined in terms of any combinable respects.

Although some embodiments and modifications thereof have been described above, the technical scope of the present disclosure is not limited to the embodiments or modifications described above, but defined on the basis of claims. Further, the technical scope of the present disclosure includes the scope of equivalents with changes from the scope of claims added, the changes being irrelevant to the essence of the present disclosure.

1. An electronic timepiece comprising:
a rotatable annular member;
a substrate having at least one protrusion; and
a sheet-like component disposed between the substrate and the annular member,
wherein the sheet-like component is controlled in position by the at least one protrusion, and
wherein the annular member is supported by the at least one protrusion.

2. The electronic timepiece according to claim 1, wherein a dimension of the at least one protrusion in a radial direction perpendicular to a rotation axis of the annular member is less than a width of the annular member from an inner circumference to an outer circumference thereof.

3. The electronic timepiece according to claim 1, wherein the at least one protrusion is disposed at a position corresponding to a region of the inner circumference of the annular member.

4. The electronic timepiece according to claim 1, wherein the annular member is supported by the at least one protrusion, thereby being disposed so as not to be in contact with the sheet-like component.

5. The electronic timepiece according to claim 1, wherein the at least one protrusion is arc-shaped with respect to a center of the annular member.

6. The electronic timepiece according to claim 1, wherein the at least one protrusion includes:
a first protrusion that determines a position of the sheet-like component in a radial direction perpendicular to a rotation axis of the annular member; and
a second protrusion that determines the position of the sheet-like component in the radial direction and a circumferential direction around the rotation axis of the annular member.

7. The electronic timepiece according to claim 6,
wherein the sheet-like component has a first hole, and
wherein the sheet-like component is positioned with respect to the substrate by the second protrusion being fitted into the first hole.

8. The electronic timepiece according to claim 7,
wherein the substrate has a boss,
wherein the sheet-like component has a second hole corresponding to the boss, and
wherein the sheet-like component is positioned with respect to the substrate by the boss being fitted into the second hole.

9. The electronic timepiece according to claim 8, wherein the second protrusion and the boss are disposed substantially symmetrically with respect to a virtual center position of the sheet-like component.

10. The electronic timepiece according to claim 1, further comprising a hold-down member that holds down the annular member,
wherein the sheet-like component has:
an annular region; and
an extension extending from the annular region, and
wherein the extension is held down by the hold-down member.

11. The electronic timepiece according to claim 8, further comprising a hold-down member that holds down the annular member,
wherein the sheet-like component has:
an annular region;
a first extension extending from the annular region at a position corresponding to the second protrusion and the first hole; and
a second extension extending from the annular region at a position corresponding to the boss and the second hole, and
wherein the first extension and the second extension are held down by the hold-down member.

12. The electronic timepiece according to claim 1, wherein the sheet-like component is a solar panel.

13. The electronic timepiece according to claim 1, wherein the annular member is a date indicator.

14. The electronic timepiece according to claim 1, wherein the sheet-like component includes an arc-shaped gallium solar panel and a decorative sheet having a thickness substantially equal to a thickness of the gallium solar panel.
